(19) United States
(12) Patent Application Publication
(10) Pub. No.: US 2023/0085228 A1
(43) Pub. Date: Mar. 16, 2023

(54) METHOD AND DEVICE FOR PRODUCING SPUNBONDED FABRIC

(71) Applicant: LENZING AKTIENGESELLSCHAFT, 4860 Lenzing (AT)

(72) Inventors: Ibrahim Sagerer-Foric, 4840 Vöcklabruck (AT); Rudolf Kern, 4840 Vöcklabruck (AT); Alexander Teubl, 4851 Gampern (AT); Wolfgang Engl, 4802 Ebensee (AT)

(21) Appl. No.: 17/801,615

(22) PCT Filed: Feb. 24, 2021
(86) PCT No.: PCT/EP2021/054495

§ 371 Date: Aug. 23, 2022

(30) Foreign Application Priority Data
Feb. 24, 2020 (EP) 20159098.1

(51) Int. Cl. D04H 3/16; D01D 5/06; D01D 5/098; D01F 2/02; D04H 3/013; B29C 48/05; B29C 48/345; B29C 48/00

(52) U.S. Cl. CPC D04H 3/16; D01D 5/06; D01D 5/0985; D01F 2/02; D04H 3/013; B29C 48/05; B29C 48/345; B29C 48/0018; B29C 48/0021; D04H 3/03

(57) ABSTRACT

A process for the production of spunbonded nonwoven (1) and a device for this purpose are shown, wherein a spinning mass (2) is extruded through a plurality of nozzle holes of at least one spinneret (3) to form filaments (4) and the filaments (4) are charged with a drawing air stream to be drawn in an extrusion direction, wherein the filaments (4) are deposited on a perforated conveying device (9) to form a spunbonded nonwoven (1) and wherein the spunbonded nonwoven (1) is subsequently subjected to at least one washing (10) and one drying (12) by means of hot air (15), with, in each case, one exhaust air stream (18, 19) being discharged during the drawing and washing (10). So as to be able to reduce the energy consumption in the process during the drying of the spunbonded nonwoven without decreasing the product quality, it is suggested that the hot air (15) for drying (12) is generated at least partially by preheating an air stream (16) by means of one of the exhaust air streams (18, 19) from the drawing and washing (10).

### BACKGROUND OF THE INVENTION

### Field of the Invention

The invention relates to a device and a process for the production of spunbonded nonwoven, wherein a spinning mass is extruded through a plurality of nozzle holes of at least one spinneret to form filaments and the filaments are charged with a drawing air stream to be drawn in an extrusion direction, wherein the filaments are deposited on a perforated conveying device to form a spunbonded nonwoven and wherein the spunbonded nonwoven is subsequently subjected to at least one washing and one drying by means of hot air, with, in each case, one exhaust air stream being discharged during the drawing and washing.

### Prior Art

The production of spunbonded nonwovens and, respectively, nonwoven fabrics by the spunbond process, on the one hand, and by the meltblown process, on the other hand, is known from the prior art. In the spunbond process (e.g., GB 2 114 052 A or EP 3 088 585 A1), the filaments are extruded through a nozzle and pulled off and drawn by a drawing unit located underneath. By contrast, in the meltblown process (e.g., U.S. Pat. Nos. 5,080,569 A, 4,380,570 A or 5,695,377 A), the extruded filaments are entrained and drawn by hot, fast process air as soon as they exit the nozzle. In both technologies, the filaments are deposited in a random orientation on a deposit surface, for example, a perforated conveyor belt, to form a nonwoven fabric, are carried to post-processing steps and finally wound up as nonwoven rolls.

It is also known from the prior art to produce cellulosic spunbonded nonwovens according to the spunbond technology (e.g., U.S. Pat. No. 8,366,988 A) and according to the meltblown technology (e.g., U.S. Pat. Nos. 6,358,461 A and 6,306,334 A). A lyocell spinning mass is thereby extruded and drawn in accordance with the known spundbond or meltblown processes, however, prior to the deposition into a nonwoven, the filaments are additionally brought into contact with a coagulant in order to regenerate the cellulose and produce dimensionally stable filaments. The wet filaments are finally deposited in a random orientation as a nonwoven fabric.

In comparison to thermoplastic spunbonded nonwoven fabrics or staple fibre nonwoven fabrics, a very high dryer performance is required for drying cellulosic spunbonded nonwoven fabrics, since not only do the spunbonded nonwovens manufactured, for example, directly from a lyocell spinning mass exhibit a high water retention capacity and carry a lot of water into the dryer, but the crystallization of the cellulose molecules is also completed only by the drying step.

The dryers commonly used for drying nonwoven fabrics are described, for example, in DE 10 2009 016 019 A1 and DE 10 2012 109 878 A1. Nonwoven fabric dryers are usually designed as through-air dryers and are arranged downstream of a hydroentanglement plant. In most cases, a carding machine, by means of which the nonwoven is produced, is located upstream of the hydroentanglement.

However, in the production of cellulosic spunbonded nonwoven, a high level of water evaporation within a short time is required, as compared to the production of conventional nonwoven fabrics, and this is associated with a high energy consumption. For example, with cellulosic spunbonded nonwovens, normally 2 to 4 times the amount of water must be evaporated in the dryer, as compared to cellulosic staple fibre nonwoven fabrics.

In the prior art, the air in the dryer is circulated and heated up repeatedly so as to achieve the high water evaporation and still dry in an energy-saving manner. Only a part is discharged as exhaust air and is used for preheating the fresh air. However, the constant enrichment of the hot air in the dryer with water vapour has the effect that the temperature of the hot air in the dryer has to be heated to above 150° C. in order to maintain the required evaporation capacity. However, especially in the drying of cellulosic spunbonded nonwovens, these high temperatures have negative effects, particularly a yellowing and an embrittlement of the product.

The prior art thus fails to offer a satisfactory solution for the energy-efficient high-performance drying of cellulosic spunbonded nonwoven without adversely affecting the product properties.

### SUMMARY OF THE INVENTION

Therefore, it is the object of the present invention to improve a process of the initially mentioned type in such a way that the energy consumption during the drying of the spunbonded nonwoven can be reduced without decreasing the product quality.

The invention achieves the object that is posed in that the hot air for drying is generated at least partially by preheating an air stream by means of one of the exhaust air streams from the drawing and washing.

If the hot air for drying is preheated at least partially by preheating an air stream by means of one of the exhaust air streams from the drawing and washing, on the one hand, the air stream can be reliably preheated to produce the hot air for drying and, at the same time, the energy demand for drying the spunbonded nonwoven can be minimized.

This is true especially if fresh air is used for the air stream and is heated by means of one of the exhaust air streams from the drawing and washing to produce the hot air. By using dry fresh air and heating the fresh air to produce hot air, high-performance drying at lower temperatures is permitted, and, thus, gentle drying of the product is enabled without sacrificing quality. If, on the other hand, as in the prior art, the exhaust air from drying is returned to drying as air that has already been preheated, this leads to an increase in the moisture content in the hot air, and the efficiency during drying will decrease. If, however, fresh air is supplied instead and is heated to produce hot air, a large part of the energy stored in the exhaust air of the dryer is lost, whereby the energy expenditure for drying rises sharply.

The efficiency of drying can be improved further if the spunbonded nonwoven is charged with the hot air during drying and the hot air enriched with water vapour is discharged from the drying as an exhaust air stream. By enriching the hot air with water vapour, the efficiency of drying decreases as the moisture content increases. By contrast, the evaporation rate of water from the spunbonded nonwoven can be kept at a consistently high level through a continuous exchange of air, while the exhaust air stream is being discharged.

Furthermore, if the exhaust air stream from drying is used at least partially as a drawing air stream for drawing the extruded filaments in the extrusion direction, the energy consumption of the entire process can be reduced further. Since, on the one hand, the exhaust air stream from drying is warmer than the ambient air used otherwise for drawing, less energy is required for heating the drawing air stream. At the same time, the exhaust air stream already has a moisture content which is advantageous for drawing the filaments, whereby an additional conditioning of the drawing air stream with vapour may be omitted.

In particular with regard to cellulosic spunbonded nonwovens, it has been found that the moistening of the drawing air stream may have a positive effect on the product properties of the finished spunbonded nonwoven, but the costs for an additional vapour injection would be very high in order to achieve the desired moisture content. Since the exhaust air stream from drying naturally has a very high moisture content, it has been shown that it can reliably be used directly or at least partially as a drawing air stream and, thus, no additional energy is required for heating and humidifying the drawing air stream.

The temperature of the exhaust air stream from drying, which is introduced as a drawing air stream for drawing the filaments, is advantageously between 80° C. and 160° C., preferably between 90° C. and 140° C., particularly preferably between 100° C. and 130° C. In addition, the moisture content of the exhaust air stream is advantageously between 5 g/kg and 500 g/kg, preferably between 10 g/kg and 250 g/kg, particularly preferably between 20 g/kg and 150 g/kg. Such an exhaust air stream can be reliably suited as a drawing air stream and might have a positive effect on the product properties of the finished spunbonded nonwoven, such as the filament diameter.

The process according to the invention thus enables, in particular, a minimization of the total energy consumption for drying and for conditioning the drawing air stream. As a result, drying may also be operated, according to the invention, with a higher supply of fresh air and at lower temperatures, and a high evaporation rate for a gentle drying of the product can still be achieved.

For example, the hot air for drying can advantageously be heated to a temperature of less than or equal to 150° C., in particular of less than or equal to 140° C., particularly preferably of less than or equal to 130° C.

The evaporation rates of water that are achieved, according to the invention, by charging the spunbonded nonwoven with hot air during drying may range between 500 and 1500 kg/h, in particular between 600 and 1400 kg/h, particularly preferably between 700 and 1300 kg/h, per metre of spunbonded nonwoven width.

The advantages of the process as described above take effect especially if the spinning mass is a lyocell spinning mass, i.e., a solution of cellulose in a direct solvent for cellulose.

Such a direct solvent for cellulose is a solvent in which the cellulose is present in a dissolved state in a non-derivatized form. This can preferably be a mixture of a tertiary amine oxide, such as NMMO (N-methylmorpholine-N-oxide), and water. Alternatively, however, ionic liquids or, respectively, mixtures with water are, for example, also suitable as direct solvents.

In this case, the content of cellulose in the spinning mass may range from 3% by weight to 17% by weight, in preferred embodiment variants from 5% by weight to 15% by weight, and in particularly preferred embodiment variants from 6% by weight to 14% by weight.

The throughput of cellulose per spunbonded nonwoven nozzle may range from 5 kg/h to 500 kg/h per m of nozzle length.

The moisture content of the spunbonded nonwoven before drying may range between 0.5 kg and 8 kg water per kg of cellulose, preferably between 1 kg and 6 kg water per kg of cellulose, particularly preferably between 2 kg and 4 kg water per kg of cellulose.

The relative moisture content of the spunbonded nonwoven after drying may be below 30%, preferably below 20%, particularly preferably below 14%.

In addition, the internal structure of the spunbonded nonwoven can be reliably controlled if the filaments that have been extruded from the spinneret and drawn are partially coagulated.

For this purpose, a coagulation air stream comprising a coagulation liquid can be allocated to the spinneret for an at least partial coagulation of the filaments, whereby the internal structure of the spunbonded nonwoven can be controlled specifically. In this case, a coagulation air stream can preferably be a fluid containing water and/or a fluid containing coagulant, for example, gas, mist, vapour, etc.

If NMMO is used as a direct solvent in the lyocell spinning mass, the coagulation liquid may be a mixture of demineralized water and 0% by weight to 40% by weight of NMMO, preferably 10% by weight to 30% by weight of NMMO, particularly preferably 15% by weight to 25% by weight of NMMO. A particularly reliable coagulation of the extruded filaments can thereby be achieved.

The present invention furthermore relates to a device for the production of spunbonded nonwoven according to claim 10.

If at least one of the suctions of the drawing device and the washing device is flow-connected to the heat exchanger of the dryer in the device according to the invention, a device for the production of spunbonded nonwoven can be created in a structurally very simple manner, which is characterized by low energy consumption and, hence, minor operating costs. Thus, both the exhaust air streams from the drawing device and from the washing device, which usually have a larger amount of residual energy, can be used for heating the hot air for the dryer.

In this context, “flow-connected” is understood to mean the existence of a connection for enabling a flow of fluids between two devices, which, in particular, is continuous.

If the outlet of the dryer is furthermore flow-connected to the heat exchanger of the dryer, the exhaust air stream from the dryer, which usually has residual heat and a high moisture content, can also be used at least partially for heating fresh air to produce the hot air.

The energy demand of the entire device can be reduced further if the outlet of the dryer is flow-connected to the drawing device for the supply of the drawing air stream. In this way, the exhaust air stream from the dryer can be supplied directly to the drawing device as a drawing air stream. Thus, it can be ensured that energy losses within the framework of the device are minimized.

If the suction for discharging the exhaust air stream from the drawing device is provided in the area of the perforated conveying device, a structurally simple suction of the spent drawing air stream may occur through the perforated conveying device.

If the device comprises several spinnerets with associated drawing devices, with the suctions of the drawing devices being flow-connected to the heat exchanger of the dryer, several spinning systems can be positioned one behind the other in order to produce multi-layered spunbonded nonwovens and dry them using the device according to the invention. In this case, the suctions for discharging the exhaust air streams of all the drawing devices can be flow-connected to the dryer and can thus further reduce the energy demand for heating the fresh air. Even in case of several exhaust air streams from one or several washings, the corresponding suctions can be flow-connected to the dryer.

Conversely, the exhaust air stream of the dryer can thus be flow-connected to a plurality of drawing devices for the supply of drawing air, whereby a particularly efficient usage of the exhaust air stream from the dryer may result.

According to the invention, also several dryers can be provided one behind the other, with the spunbonded nonwoven passing through the several dryers in sequence. In this case, the spunbonded nonwoven can already be dried at temperatures of below 100° C., in preferred variants at temperatures of below 90° C., or in particularly preferred variants at temperatures of below 80° C.

By means of the device according to the invention for the production of cellulosic spunbonded nonwoven, with energy recovery from the moist and hot exhaust air streams downstream of the suctions of the drawing device and the washing, the need for a circulation of hot air in the dryer can be reduced and the proportion of fresh air in the dryer can be increased. Finally, higher evaporation rates can thereby be achieved with a lower temperature of the hot air in the dryer.

### BRIEF DESCRIPTION OF THE DRAWINGS

In the following, the embodiment variants of the invention are illustrated on the basis of several figures.

FIG. 1 shows a schematic illustration of the process according to the invention and of the device according to a first embodiment variant, and

FIG. 2 shows a schematic illustration of the process according to the invention and of the device according to a second embodiment variant.

### DETAILED DESCRIPTION OF THE INVENTION

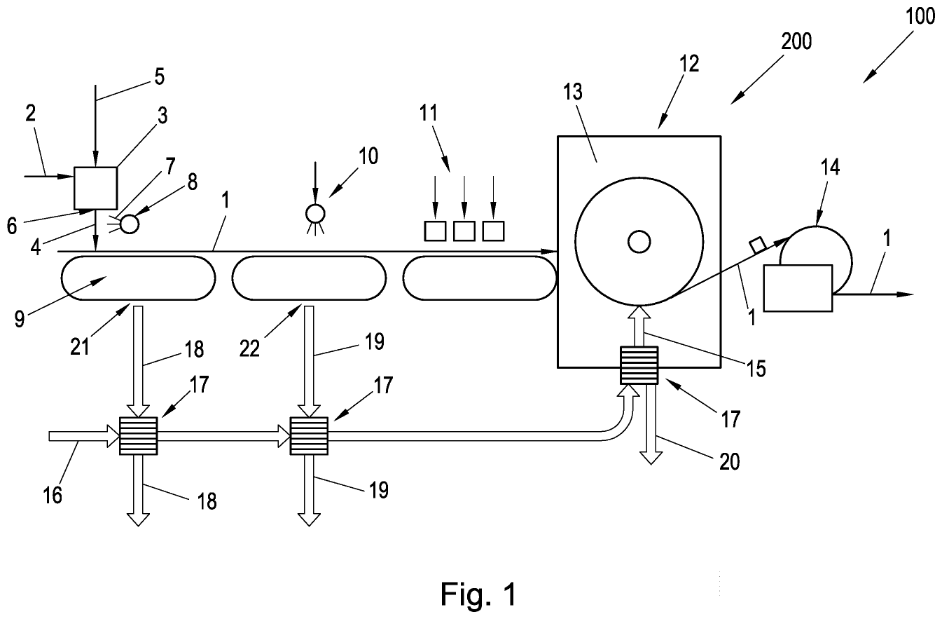

In FIG. 1, a process 100 for the production of cellulosic spunbonded nonwoven 1 according to a first embodiment variant and, respectively, a device 200 for performing the process 100 are shown. In a first process step, a spinning mass 2 is produced from a cellulosic raw material and supplied to a spinneret 3 of the device 200. In this case, the cellulosic raw material for producing the spinning mass 2, which production is not shown in further detail in the figures, can be a conventional pulp made of wood or other plant-based starting materials. However, it is also conceivable that the cellulosic raw material consists at least partly of production waste from the production of spunbonded nonwoven or recycled textiles. In this case, the spinning mass 2 is a solution of cellulose in NMMO and water, with the cellulose content in the spinning mass ranging between 3% by weight and 17% by weight.

In a following step, the spinning mass 2 is then extruded through a plurality of nozzle holes in the spinneret 3 to form filaments 4. The extruded filaments 4 are then accelerated and drawn in the extrusion direction by being charged with a drawing air stream. For generating the drawing air stream, drawing air 5 is supplied to a drawing device 6 in the spinneret 3, with the drawing device 6 ensuring that the drawing air stream exits the spinneret 3 and the filaments 4 are accelerated after their extrusion.

In one embodiment variant, the drawing air stream can emerge between the nozzle holes of the spinneret 3. In a further embodiment variant, the drawing air stream may alternatively emerge around the nozzle holes. However, this is not illustrated in further detail in the figures. Such spinnerets 3 comprising drawing devices 6 for generating a drawing air stream are known from the prior art (U.S. Pat. Nos. 3,825,380 A, 4,380,570 A, WO 2019/068764 A1).

Moreover, the extruded and drawn filaments 4 are charged with a coagulation air stream 7, which is provided by a coagulation device 8. The coagulation air stream 7 usually comprises a coagulation liquid, for example, in the form of vapour, mist, etc. Due to the contact of the filaments 4 with the coagulation air stream 7 and the coagulation liquid contained therein, the filaments 4 are coagulated at least partly, which, in particular, reduces adhesions between the individual extruded filaments 4.

The drawn and at least partially coagulated filaments 4 are then deposited in a random orientation on the conveying device 9, forming the spunbonded nonwoven 1 there. After its formation, the spunbonded nonwoven 1 is subjected to washing 10 and hydroentanglement 11.

In a following step, the washed and hydroentangled spunbonded nonwoven 1 is then subjected to drying 12 in a dryer 13 in order to remove the remaining moisture and to obtain a finished spunbonded nonwoven 1. Finally, the process 200 is concluded by optionally winding 14 and/or packaging the finished spunbonded nonwoven 1.

During the drying 12 in the dryer 13, the spunbonded nonwoven 1 is charged with hot air 15. In doing so, the hot air 15 is formed by heating an air stream 16, in particular fresh air 16, by passing it through a plurality of heat exchangers 17. As shown in FIG. 1, the heat exchangers 17 are fed by the exhaust air stream 18 from the drawing, the exhaust air stream 19 from the washing 10, and the exhaust air stream 20 from the drying 12. In doing so, the residual heat in the exhaust air streams 18, 19, 20 in the heat exchangers 17 is transferred to the fresh air 16, which is thus heated.

Underneath the drawing, the device 100 therefore comprises a suction 21 for discharging the spent drawing air stream as an exhaust air stream 18. In this case, the suction 21 is advantageously arranged in the area of the perforated conveying device 9 on which the spunbonded nonwoven 1 is formed. The same applies to the washing 10, where a suction 22 is provided as an exhaust air stream 19 for discharging the air laden with moisture. In this case, the suction 20 and the suction 21 are each flow-connected to a heat exchanger 17. In a similar way, the outlet of the dryer 13 is flow-connected to the heat exchanger 17 for discharging the spent hot air laden with water vapour as an exhaust air stream 20.

In one embodiment variant, as shown in FIG. 1, the heat exchangers 17 can be designed as separate heat exchangers 17, and, thus, they can allow the air stream 16 or, respectively, the fresh air 16 to be gradually heated to produce the hot air 15. In a further embodiment variant, which is not illustrated in further detail in the figures, the heat exchanger 17 can alternatively be designed as a single unit, with all exhaust air streams 18, 19, 20 running through the single heat exchanger 17.

The exhaust air streams 18, 19, 20 from the drawing, the washing 10 and the drying 12 are then discharged after they have been passed through the heat exchangers 17. For example, in a further embodiment, which is not illustrated in further detail in the figures, the exhaust air streams 18, 19, 20 can thus be treated further for the recovery of water and/or solvent.

Due to the multi-stage heating of the fresh air 16 in the heat exchangers 17 by various exhaust air streams 18, 19, 20 accumulating in the course of the process 100 for the production of the cellulosic spunbonded nonwoven 1, a process with a holistic energy use can be created, which minimizes energy losses and, in particular, allows a reliable and fast drying 13 of the spunbonded nonwoven 1.

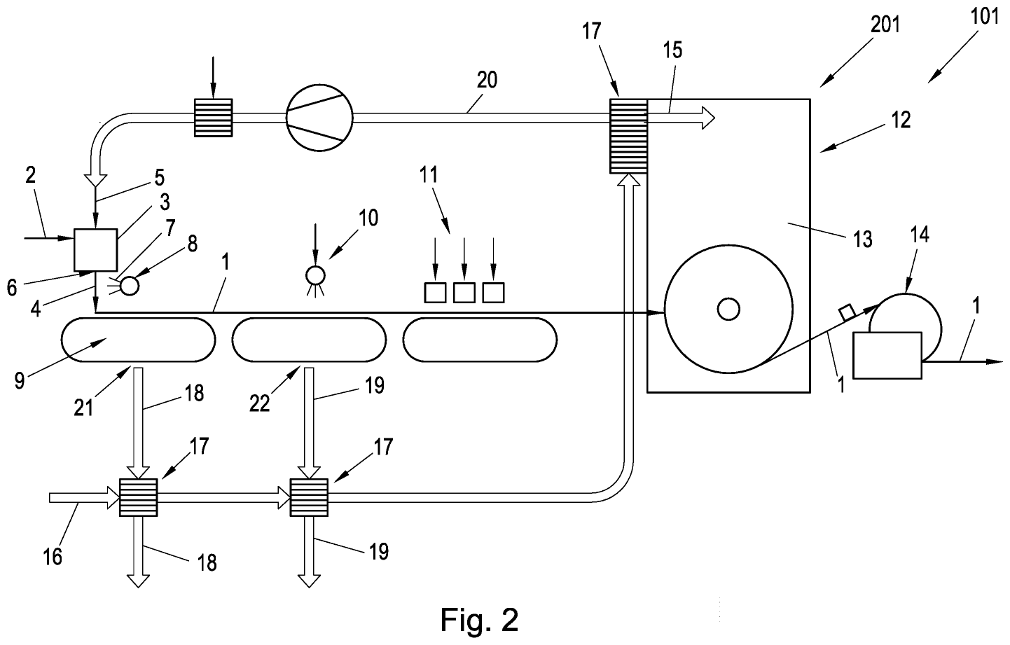

FIG. 2 shows a process 101 according to the invention for the production of cellulosic spunbonded nonwoven 1 according to a second embodiment variant and, respectively, a device 201 for this purpose. The process 101 differs from the process 100 illustrated in FIG. 1 in that the hot air enriched with water vapour is discharged from the drying 12 as an exhaust air stream 20 through the heat exchanger 17 and, after having passed through the heat exchanger 17, is supplied further to the drawing device 6 as drawing air 5, for which purpose the outlet of the dryer 13 for the exhaust air stream 20 is flow-connected to the drawing device 6. A particularly efficient energy use for the entire device 101 or, respectively, the entire process 201 can thus be achieved. With regard to further features, reference is made to the above explanations concerning FIG. 1.

### Example

The invention is demonstrated below using an example. In the course of the process according to the invention, both the exhaust air stream from the drawing and the exhaust air stream from the washing were supplied to a heat exchanger in order to heat fresh air.

In doing so, the cellulose throughput was 200 kg/h with a spunbonded nonwoven width of 1 m, and the spunbonded nonwoven that was produced had a basis weight of 45 g/m2. In this case, the moisture content of the spunbonded nonwoven on entry into the dryer amounted to about 3 kg of water per kg of cellulose. After drying, the finished spunbonded nonwoven had a relative moisture content of below 10%.

In this case, it has been shown that, depending on the negative pressure in the deposit surface, the temperature and the relative moisture content of the exhaust air stream from the spunbonded nonwoven deposition vary, namely between about 40° C. and 70% at 80 mbar negative pressure in the spunbonded nonwoven deposit surface and about 60° C. and 30% at 140 mbar negative pressure in the spunbonded nonwoven deposit surface.

The temperature and the relative moisture content of the exhaust air stream from the washing, in turn, varied between 40° C. and 80% at 150 mbar negative pressure and 90° C. and 30% at 250 mbar negative pressure, depending on the negative pressure in the suction pipes of the washing.

Furthermore, it has been shown that the volume flows of the two exhaust air streams are many times greater than the volume flow of fresh air, which is supplied to the dryer. For example, the exhaust air stream from the spunbonded nonwoven deposition ranged between 15,000 Nm3 (standard cubic metres) and 30,000 Nm3 per hour, and the exhaust air stream from the washing ranged between 10,000 Nm3 and 20,000 Nm³ per hour, while only between 8,000 Nm3 and 16,000 Nm³ of fresh air was supplied to the dryer. Without the heat recovery according to the invention from the exhaust air streams, a lot of energy would be lost, on the one hand, and a lot of energy would be required for heating the fresh air, on the other hand, so as to heat it from, e.g., 15° C. to, e.g., 140° C.

As a result of the heat recovery according to the invention by supplying the exhaust air streams from the drawing and the washing, the energy costs for drying could be reduced by up to 70%, since the fresh air could be tempered to 70° C. already after it had been passed through the heat exchangers.

Furthermore, the exhaust air stream from drying was introduced as drawing air for drawing the filaments, wherein it had a temperature of between 80° C. and 160° C. with a moisture content of between 5 g/kg and 500 g/kg. By using the exhaust air stream from drying as drawing air, the properties of the spunbonded nonwoven could be positively influenced. For example, the fibre diameter could thus be reduced by up to 50%, while maintaining the same drawing air pressure and spinning mass throughput.

Compared to the prior art, in which the adjustment of the moisture content in the drawing air is effected, for example, via vapour injection and is very cost-intensive due to the large amounts of air that are required, the costs for humidifying and heating the drawing air could be reduced by up to 70%, using the already very humid exhaust air stream from drying.

1. A process for producing a spunbonded nonwoven, comprising
extruding a spinning mass through a plurality of nozzle holes of at least one spinneret to form filaments
charging the filaments with a drawing air stream to be drawn in an extrusion direction,
depositing the filaments on a perforated conveying device to form the spunbonded nonwoven and
subsequently subjecting the spunbonded nonwoven to at least one washing and at least one drying by means of hot air, with, in each case, at least one exhaust air stream being discharged during drawing and the at least one washing, wherein the hot air for the at least one drying is generated at least partially by preheating an air stream by means of the at least one exhaust air stream from the drawing and the at least one washing.

2. The process according to claim 1, wherein fresh air is used as the air stream.

3. The process according to claim 1, wherein the spunbonded nonwoven is charged with the hot air during the at least one drying and the hot air enriched with water vapor is discharged from the at least one drying as an exhaust air stream.

4. The process according to claim 3, wherein the exhaust air stream from the at least one drying is used at least partially as the drawing air stream for drawing the extruded filaments in the extrusion direction.

5. The process according to claim 3, wherein the air stream for the at least one drying is preheated at least partially by the exhaust air stream from the at least one drying.

6. The process according to claim 1, wherein the air stream for the at least one drying is heated to a temperature of less than or equal to 150° C., optionally less than or equal to 140° C., or optionally less than or equal to 130° C.

7. The process according to claim 1, wherein between 500 and 1,500 kg/h, optionally between 600 and 1,400 kg/h, or optionally between 700 and 1,300 kg/h water per meter of a width spunbonded nonwoven is evaporated from the spunbonded nonwoven by charging the spunbonded nonwoven with the hot air during the at least one drying.

8. The process according to claim 1, wherein the spunbonded nonwoven is a cellulosic spunbonded nonwoven, and the spinning mass is a solution of cellulose in a direct solvent, optionally a tertiary amine oxide in an aqueous solution.

9. The process according to claim 1, wherein, upon extrusion from the at least one spinneret, the filaments are coagulated at least partly, optionally by being charged with a coagulation air stream comprising a coagulation liquid.

10. A device for producing a spunbonded nonwoven, comprising:
at least one spinneret for extruding a spinning mass to form filaments;
a drawing device for drawing the extruded filaments by means of a drawing air stream, the drawing device being allocated to the at least one spinneret, wherein the drawing device comprises a first suction for discharging a first exhaust air stream,
a perforated conveying device for depositing the filaments and forming the spunbonded nonwoven;
a washing device for washing the spunbonded nonwoven after the spunbonded nonwoven has been formed, wherein the washing device comprises a second suction for discharging a second exhaust air stream;
a dryer for drying the spunbonded nonwoven by means of hot air downstream of the washing device, the dryer comprising at least one inlet for the hot air and an outlet for a third exhaust air stream; and
a heat exchanger for heating an air stream to produce the hot air, wherein at least one of the first section of the drawing device and the second suction of the washing device are flow-connected to the heat exchanger.

11. The device according to claim 10, wherein the outlet of the dryer is flow-connected to the heat exchanger.

12. The device according to claim 10, wherein the outlet of the dryer is flow-connected to the drawing device for supplying the drawing air stream.

13. The device according to claim 10, wherein the first suction for discharging the first exhaust air stream from the drawing device is provided in an area of the perforated conveying device.

14. The device according to claim 10, wherein the device comprises a plurality of the at least one spinneret associated with a plurality of the drawing devices, wherein each of the first suction of the plurality of the drawing device being flow-connected to the heat exchanger.
